(19) United States
(12) Patent Application Publication
(10) Pub. No.: US 2026/0075147 A1
(43) Pub. Date: Mar. 12, 2026

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: SHINICHI KANEMATSU, Chiba (JP)

(21) Appl. No.: 19/318,834

(22) Filed: Sep. 4, 2025

(30) Foreign Application Priority Data
Sep. 11, 2024 (JP) 2024-157738

(51) Int. Cl. H04N 1/00; H04N 1/21

(52) U.S. Cl. CPC H04N 1/00408; H04N 1/21; H04N 2201/214

(57) ABSTRACT

The present disclosure is directed to an image processing apparatus comprising: a storage unit that stores a set of instructions; and one or more processors that execute the set of instructions to: acquire a capacity of another storage unit, the other storage unit being a storage unit of at least one unit connected to the image processing apparatus; and cause a display unit to display a storage capacity based on the capacity of the acquired other storage unit and a capacity of the storage unit of the image processing apparatus.

### BACKGROUND

### Field of the Technology

The present disclosure relates an image processing apparatus, a control method thereof, and a storage medium.

### Description of the Related Art

In conventional image processing apparatuses, in relation to a scan function for reading an image of a document sheet and a print function for forming an image on a sheet, the amount of memory provided by the apparatus may be exceeded depending on the size of image data to be processed, and processing may not be performed correctly. In such a case, in order to correctly perform image processing desired by the user, it is necessary to reduce the size of the image data in accordance with the amount of memory of the image processing apparatus or add memory to the apparatus. However, it is necessary to notify the user of the memory insufficient state, since the memory insufficient state cannot be distinguished by appearance. Japanese Patent Laid-Open No. 2000-71531 proposes an image processing apparatus having a function of notifying the user of a usable amount of memory.

In addition, in image processing apparatuses, since the memory capacity is greatly related to the size of image data that can be processed and processing speed, some apparatuses can notify the memory capacity, which serves as a product specification, on a display unit of the image processing apparatus as capability information of the apparatus. Such memory capacity may be indicated in catalogs as an indicator of a product's capabilities or performance or may be used as a factor in customers selecting a product. In addition, manufacturers may use memory capacity as a specification value to promote a product's capabilities or performance to customers.

However, in a Multifunction Peripheral (hereinafter referred to as MFP), which is an image processing apparatus configured to include a plurality of units, each unit is provided with an independent CPU and memory, as well as an image processing memory. The units constituting the MFP include a system controller unit that comprehensively controls the entire MFP, as well as a reader unit that performs image processing, a printer unit, a FAX unit, and the like. Therefore, for example, when only the memory capacity provided in the system controller is displayed as a product specification of the MFP, there is a problem that the amount of memory provided in the MFP as a whole is not accurately represented.

### SUMMARY

The present disclosure enables realization of a mechanism for displaying a storage capacity based on a capacity of a storage unit of at least one unit connected to an image processing apparatus and a capacity of a storage unit of the image processing apparatus.

One aspect of the present disclosure provides an image processing apparatus comprising: a storage unit that stores a set of instructions; and one or more processors that execute the set of instructions to: acquire a capacity of another storage unit, the other storage unit being a storage unit of at least one unit connected to the image processing apparatus; and cause a display unit to display a storage capacity based on the capacity of the acquired other storage unit and a capacity of the storage unit of the image processing apparatus.

Another aspect of the present disclosure provides a method for controlling an image processing apparatus including a storage unit, the method comprising: acquiring a capacity of another storage unit, the other storage unit being a storage unit of at least one unit connected to the image processing apparatus; and displaying a storage capacity based on the acquired capacity of the other storage unit and a capacity of the storage unit of the image processing apparatus.

Still another aspect of the present disclosure provides a non-transitory computer-readable storage medium storing a program for causing a computer to execute a method for controlling an image processing apparatus including a storage unit, the method comprising: acquiring a capacity of another storage unit, the other storage unit being a storage unit of at least one unit connected to the image processing apparatus; and displaying a storage capacity based on the acquired capacity of the other storage unit and a capacity of the storage unit of the image processing apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a configuration of an image processing apparatus according to one embodiment.

FIG. 2 is a diagram illustrating the image processing apparatus connected to a network according to one embodiment.

FIG. 3 is a block diagram illustrating a hardware configuration of each reader controller separated-type unit according to one embodiment.

FIG. 4 is a diagram illustrating a memory capacity holding table according to one embodiment.

FIG. 5 is a diagram illustrating an example of a device configuration screen displayed on a main body operation unit according to one embodiment.

FIG. 6 is a flowchart for explaining a processing procedure according to one embodiment.

FIG. 7 is a block diagram illustrating a hardware configuration in which a reading unit has been removed according to one embodiment.

FIG. 8 is a diagram illustrating an example of memory capacity display in a state in which the reading unit has been removed according to one embodiment.

FIG. 9 is a flowchart for explaining a processing procedure according to one embodiment.

FIG. 10 is a block diagram illustrating a reader controller integrated-type hardware configuration according to one embodiment.

FIG. 11 is a diagram illustrating an example of memory capacity display in a reader controller integrated type according to one embodiment.

FIG. 12 is a flowchart for explaining a processing procedure according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of Image Processing Apparatus

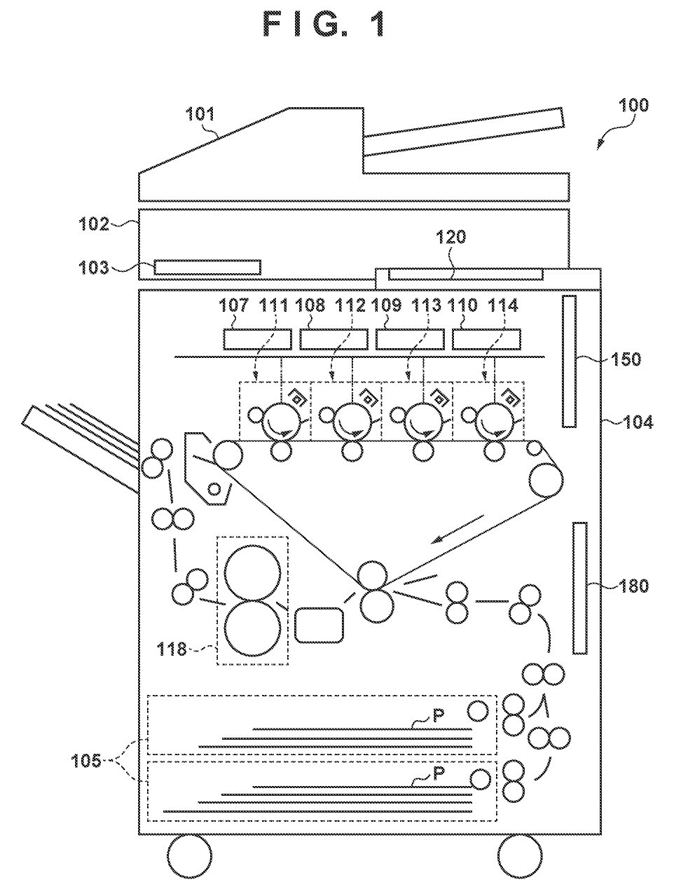

A first embodiment of the present disclosure will be described below. An example of a configuration of an image processing apparatus according to the present embodiment will be described with reference to FIG. 1. An image processing apparatus 100 illustrated in FIG. 1 is only one example of the present embodiment, and a facsimile apparatus, an inkjet printer, a multifunction peripheral, and the like that include an image reading apparatus also correspond to the image processing apparatus according to the present embodiment. Further, in the present embodiment, the image processing apparatus may be configured to include a post-processing apparatus that performs folding, stapling, or the like for binding printed sheets; a large-capacity stacking apparatus that stacks printed products; and the like.

As illustrated in FIG. 1, the image processing apparatus 100 according to the present embodiment is configured to include an automatic document feeding apparatus 101, a reading unit 102, and a reader controller 103 as an image reading apparatus above a printer engine 104. The printer engine 104 includes a paper feeding cassette 105 in which sheets P are stacked, laser scanners 107 to 110 which are electrophotographic print engines and correspond to respective YMCK colors, image forming units 111 to 114, a fixing unit 118, and the like therein. Further, the printer engine 104 includes a system controller 150, an engine controller 180, and an operation unit 120.

The system controller 150 is connected to each unit of the entire image processing apparatus 100 and integrates and controls them to realize copy, print, scan, and fax operations. The engine controller 180 is a unit that controls the printer engine 104, which forms an image by using an electrophotographic method. The operation unit 120 is provided with a screen that accepts a job operation instruction from the user and displays the status of the image processing apparatus 100 and information to be notified to the user, and is integrally controlled by the system controller 150.

### Configuration of System

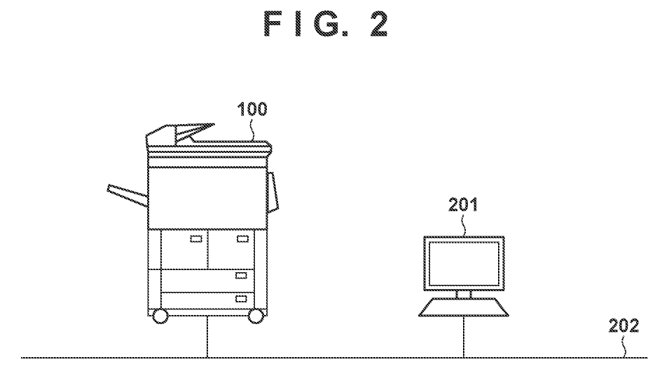

A configuration of a system that includes the image processing apparatus 100 according to the present embodiment will be described with reference to FIG. 2. Here, as an example of the present system, a form in which the image processing apparatus 100 is connected to a network 202 and various functions of the image processing apparatus 100 are used from an external apparatus 201 will be described as an example.

In the present system, in addition to operating the image processing apparatus 100 directly, the functions of the image processing apparatus 100 can also be used by performing operation instructions related to printing, scanning, and faxing from the external apparatus 201 via the network. It is also possible to display, on the external apparatus 201, the actual screen displayed on the operation unit 120 of the main body of the image processing apparatus 100 or an equivalent screen, and confirm it. In the present embodiment, a device configuration screen displayed on the main body operation unit 120, which will be described later, may also be displayed on a display unit of the external apparatus 201 and confirmed.

### Configuration of Each Controller Unit

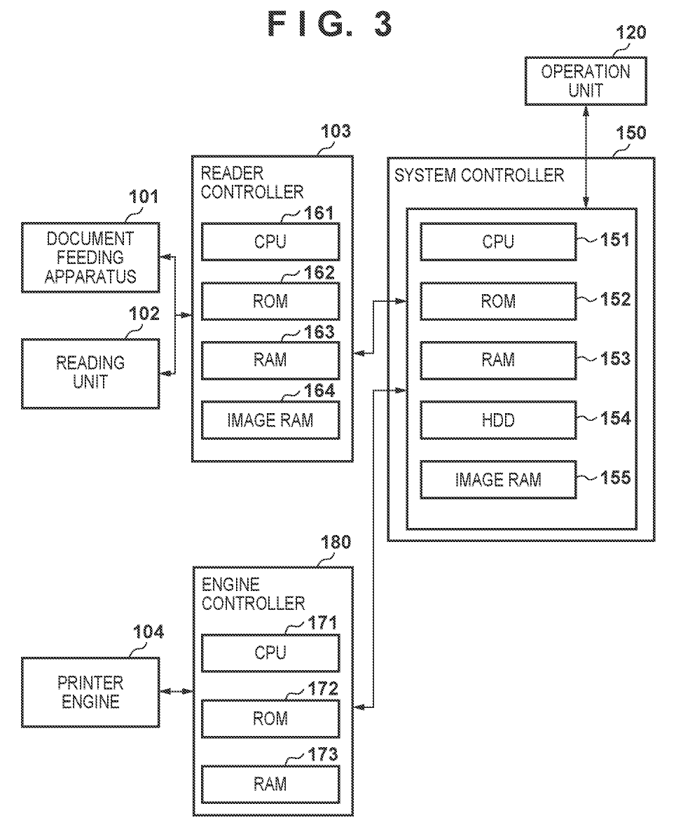

A configuration of a controller unit of each unit constituting the image processing apparatus 100 according to the present embodiment will be described with reference to FIG. 3. The image processing apparatus 100 includes the reader controller 103 of an image reading apparatus (automatic document feeding apparatus 101 and reading unit 102), the engine controller 180 of the printer engine 104, and the system controller 150 as controllers of each unit. Image RAMs 155 and 164, which will be described later, may be volatile memories (DRAMs).

The system controller 150 is configured to include a CPU 151, a ROM 152 which stores firmware, a RAM 153 which serves as a system memory for reading and executing firmware, an HDD 154 which stores various types of data, and an image processing memory 155. The CPU 151 is an example of a computer. Further, the system controller 150 is connected to be capable of communicating with the reader controller 103 and the engine controller 180. By the CPU 151 executing controller firmware read from the ROM 152, each unit is integrally controlled to realize functions of the image processing apparatus 100, such as scanning, printing, and copying. Further, between the system controller 150 and each unit, a signal line that transmits electrical signals by which whether a respective unit is connected can be determined is wired to be accessible from software. Therefore, the system controller 150 can determine the presence or absence of each unit as necessary.

The reader controller 103 is configured to include a CPU 161, a ROM 162, a RAM 163 and an image memory 164 for scanned image processing. Reader firmware is stored in the ROM 162, and by the CPU 161 reading it into the RAM 163 and executing it, document feeding and image reading operations of the automatic document feeding apparatus 101 and the reading unit 102 are performed.

The engine controller 180 is a controller unit that controls the printer engine 104 and is configured to include a CPU 171, a ROM 172 which stores engine firmware, and a RAM 173. By the CPU 171 reading the engine firmware from the ROM 172 into the RAM 173 executing it, sheet conveyance and image formation are performed by the printer engine 104, and a printing operation is realized. In the image processing apparatus 100 according to the present embodiment, since processing for an image to be outputted to the printer engine 104 is performed by the system controller 150, the engine controller 180 is configured without an image processing RAM.

### Memory Capacity Table

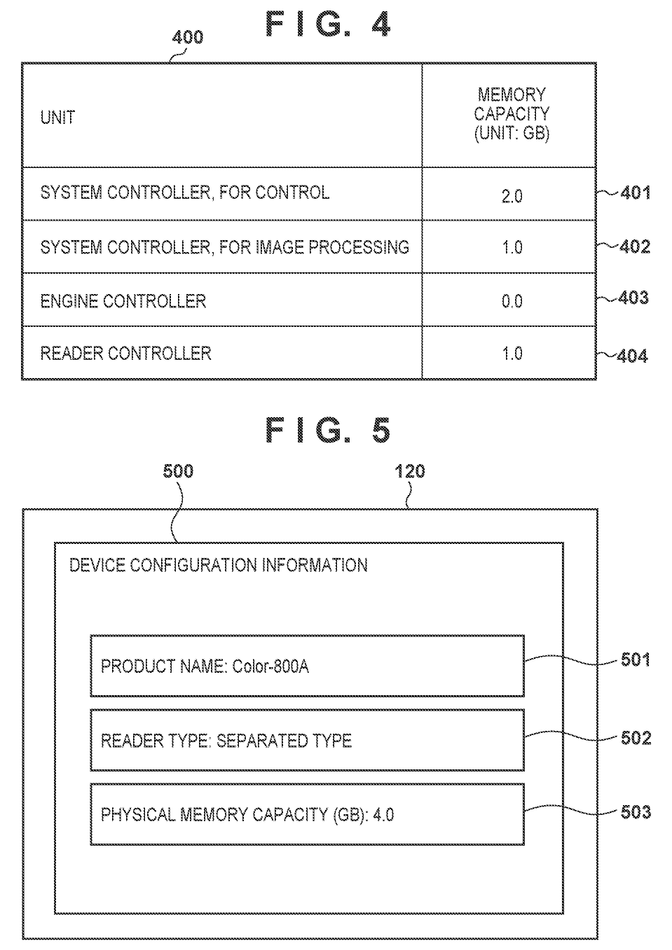

A memory capacity table 400, which holds a memory (RAM) capacity of each unit constituting the image processing apparatus 100 according to the present embodiment will be described with reference to FIG. 4. The memory capacity in the present embodiment is a total capacity of RAMs physically provided in the image processing apparatus 100, the unit is in gigabytes (hereinafter abbreviated as GB), and RAMs that are 0.1 GB or below are defined to be excluded from the total and rounded down.

The memory capacity table 400 holds memory capacities 401 to 404 of memories of respective units included in the image processing apparatus 100. Reference numeral 401 is the capacity of the RAM 153 used by the CPU 151 to execute the controller firmware among the memories of the system controller 150 and is 2.0 GB. Reference numeral 402 is the capacity of an image RAM 155 for the system controller 150 to store and process image data for image processing and is 1.0 GB in the present embodiment. Reference numeral 403 is the memory capacity of the engine controller 180, and in the present embodiment, the RAM 173 of the engine controller has a physical capacity of 0.05 GB and is less than 0.1 GB to be included in the total memory capacity and is thus 0 GB in the memory capacity table. Reference numeral 404 is a memory capacity value of the reader controller, and in the present embodiment, the RAM 163 of the reader controller is 0.03 GB, and the image RAM 164 is 1.0 GB. Therefore, the amount corresponding to the RAM 163 is excluded from the total, and 1.0 GB corresponding to the image RAM 164 is in the memory capacity table 400.

The data of the memory capacity table 400 is defined as static data and as a specification of each unit included in the image processing apparatus 100 and is stored in the HDD 154 in advance. As for the image reading apparatus, it is also possible to mount a plurality of reading units selected from a plurality of types of image reading units in accordance with a customer request. In that case, the memory capacity table describes the memory capacities of the plurality of reader controllers 103 that can be mounted and defines the capacities corresponding to the types of currently connected reader controllers 103. Further, when the configuration of the image processing apparatus 100 is changed, such as when a memory of an already mounted image reading apparatus is replaced or when another optional apparatus is connected, for example, the information of the memory capacity table 400 is updated. As for the update of the memory capacity table 400, the memory capacity table 400 is changed in accordance with the device information detected at the timing at which each device is connected. Alternatively, a configuration in which the memory capacity table 400 is changed in accordance with user input may be taken.

### Example of Screen

A screen 500 indicating device configuration information according to the present embodiment will be described with reference to FIG. 5. It is an example of the device configuration information screen 500, which presents memory capacity and is displayed on the operation unit 120. A product name 501, a reader hardware configuration type 502, and a memory capacity 503 are presented in the device configuration information screen 500 according to the present embodiment. The reader hardware configuration type indicates whether the reader controller 103 including the image RAM 164 is an integrated type, which is mounted on the same electric board as the system controller 150, or a separated type, which is mounted separately from the image reading apparatus. In the screen 500 illustrated in FIG. 5, it is indicated, in addition to the product name 501, that the reader hardware configuration type 502 is a separated type and the memory capacity 503 is 4.0 GB. The memory capacity 503 indicates the total memory capacity in one or more units that are currently connected to the image processing apparatus 100.

### Processing Procedure

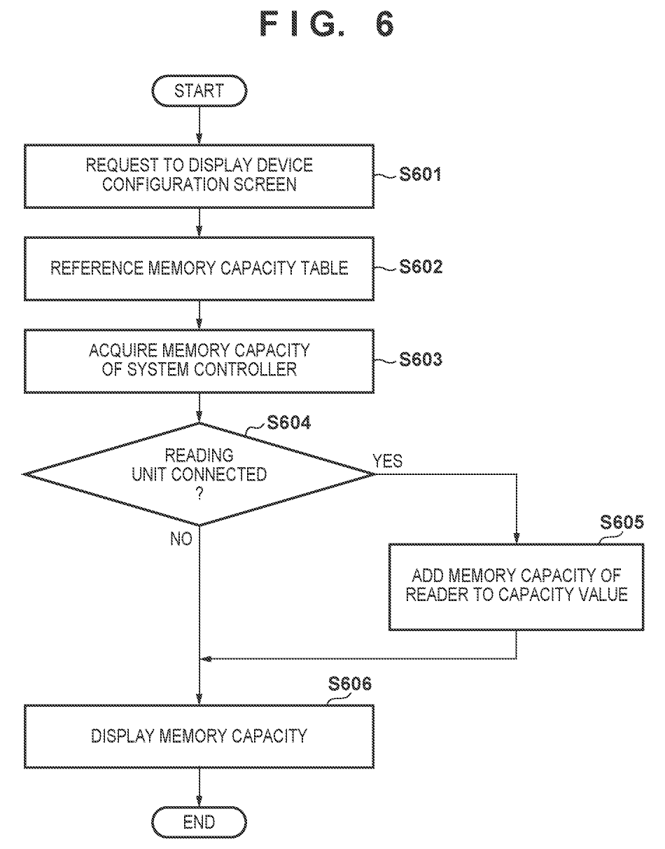

A processing procedure for displaying the device configuration information screen 500 according to the present embodiment will be described with reference to FIG. 6. The processing to be described below is realized, for example, by the CPU 151 of the system controller reading the controller firmware from the ROM 152 and executing it on the RAM 153. It is similar for subsequent flowcharts other than that of FIG. 6.

First, in step S601, the CPU 151 accepts a request to display a device configuration screen. Upon accepting the display request, in step S602 the CPU 151 reads the memory capacity table 400 from the HDD 154. In step S603, the CPU 151 first acquires the control memory capacity 401 of the system controller 150 and the image processing memory capacity 402, and acquires their total value. The acquired total value is set as a temporary value to be displayed as the memory capacity 503 of the device configuration information screen 500.

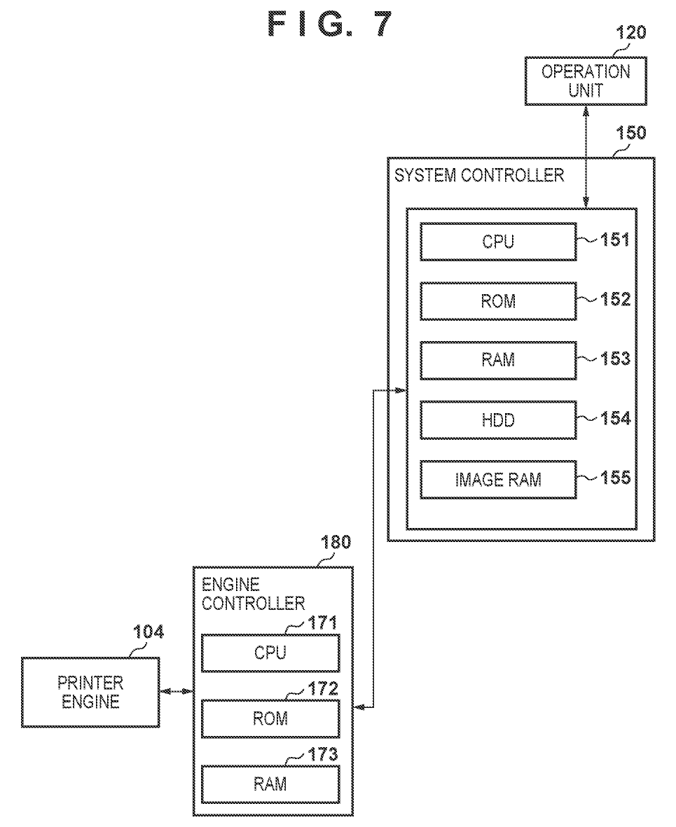

Next, in step S604, the CPU 151 confirms whether the reading unit 102, which includes the reader controller 103, is connected. In the image processing apparatus 100 according to the present embodiment, a form in which the reading unit 102 is removed (detached) and used can be selected in accordance with a request of a customer. FIG. 7 illustrates a configuration in which the reading unit 102 has been removed. In the present embodiment, the hardware configuration of the image reading apparatus is a separated type, and the reader controller 103 is implemented in the reading unit 102. The connection of the reading unit 102 is confirmed by determining whether an electrical connection line between the system controller 150 and the reader controller 103 is active. If the reading unit 102 is connected, the processing proceeds to step S605, and otherwise, the processing proceeds to step S606.

In step S605, the CPU 151 adds the memory capacity 404 of the reader controller 103 as a memory capacity value and proceeds to step S606. If the reading unit 102 is not connected in step S604, the processing proceeds to step S606 without adding the capacity 404 of the reader controller 103.

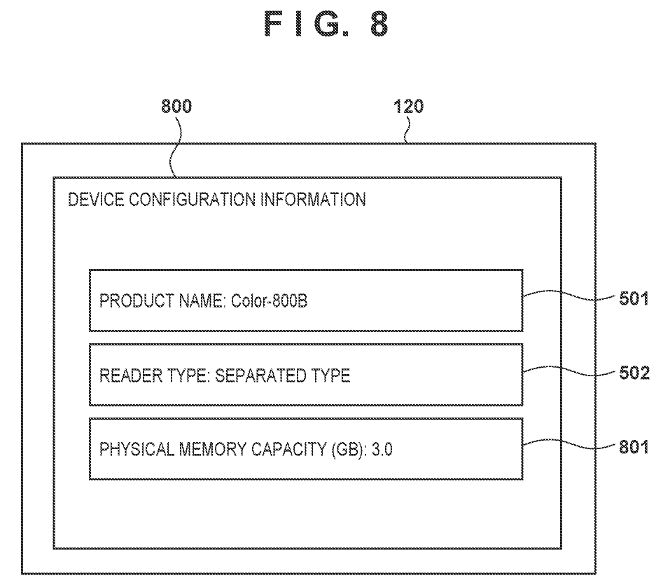

In step S606, the CPU 151 determines a capacity value to be displayed on the device configuration information screen 500 and displays the determined capacity value in the memory capacity 503 of the screen 500. When the reading unit 102 is connected, "4.0 GB" is displayed as the capacity value, and when the reading unit 102 is connected, "3.0 GB" is displayed as a memory capacity 801 as in a screen 800 illustrated in FIG. 8.

In this way, accurate memory capacity can be displayed in accordance with the unit configuration of the image processing apparatus 100. Further, in the present embodiment, the engine controller 180 is excluded from the total due to the memory capacity being less than 0.1 GB. Meanwhile, when the engine controller 180 is provided with a memory of 0.1 GB or more, a value obtained by adding a corresponding amount is displayed as the memory capacity of the device configuration screen.

In addition, when there is a possibility that another optional unit such as a post-processing apparatus may be connected, the memory capacity is acquired by determining whether each unit is connected, as in the determination of the above step S604. This makes it possible to accurately present usable memory capacity in accordance with the connected units. A configuration may be taken so as to, even if a memory is mounted on an optional unit, if it is not usable in the system controller 150 or the like, not add it to the total memory capacity. Further, although a form in which the total memory capacity of a plurality of units is presented has been described here, a configuration may be taken so as to alternatively or additionally present respective memory capacities of the individual units.

As described above, the image processing apparatus according to the present embodiment is an apparatus from which a plurality of units are detachable. The image processing apparatus holds a memory capacity for each of the plurality of units and determines one or more units connected to the image processing apparatus among the plurality of units. In addition, this image processing apparatus acquires the memory capacities included in one or more units connected to the image processing apparatus from a holding unit and presents the acquired memory capacities. Thus, according to the present embodiment, a mechanism that suitably presents memory capacity in accordance with the configuration of the image processing system, without being limited to the memory capacity of the system controller, can be provided.

### Second Embodiment

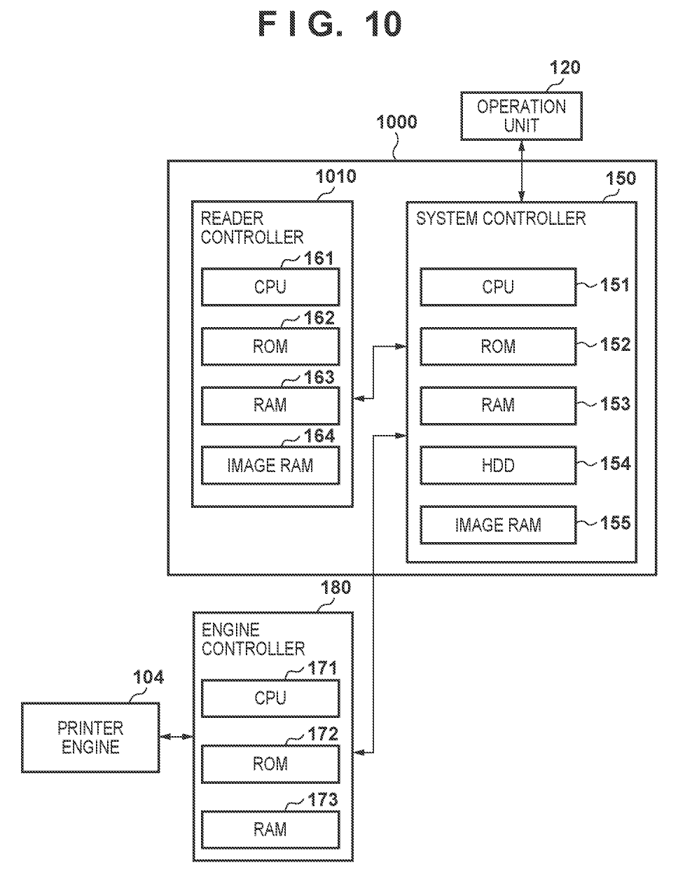

A second embodiment of the present disclosure will be described below. The reader controller 103 of the above first embodiment has a separated-type configuration in which it is separated from the system controller 150, a case where the reader controller 103 has an integrated type configuration will be described in the present embodiment. A block diagram of a case where the reading unit 102 has been removed (detached) in an integrated-type form is illustrated in FIG. 10.

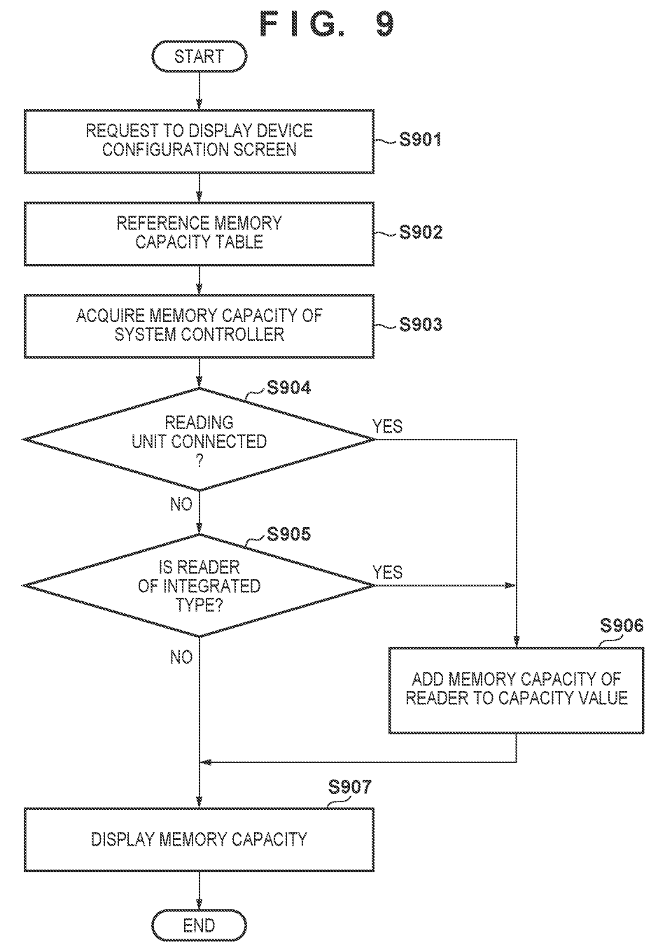

As illustrated in FIG. 10, the reading unit 102 has been physically removed and is not connected, but a reader controller 1010, which includes the image memory 164, is mounted on the same substrate 1000 as the system controller 150. The reader controller 1010 has an internal configuration similar to that of the reader controller 103, and the image memory 164 is present. Thus, when the reader controller 1010 is provided in a manner in which it is integrated with the system controller 150, the reader controller 1010 is present even when the reading unit 102 is not connected, and the image memory 164 can also be used. Therefore, it is necessary to determine whether the configuration of the reader controller 1010 is an integrated type or a separated type in the flowchart for acquiring the memory capacity illustrated in FIG. 6 described in the above first embodiment. The flowchart is illustrated in FIG. 9.

A processing procedure for displaying a device configuration information screen 1100 according to the present embodiment will be described with reference to FIG. 9. The processing to be described below is realized, for example, by the CPU 151 of the system controller reading the controller firmware from the ROM 152 and executing it on the RAM 153. The description will be omitted for steps S901 to S904 as the processing is similar to that of steps S601 to S604 of FIG. 6.

If the reading unit 102 is not connected in step S904, in step S905 the CPU 151 determines whether the type of the reader controller 1010 is an integrated type. If it is an integrated type, the processing proceeds to step S906, and the CPU 151 adds a memory capacity corresponding to the image RAM 164 and proceeds to step S907.

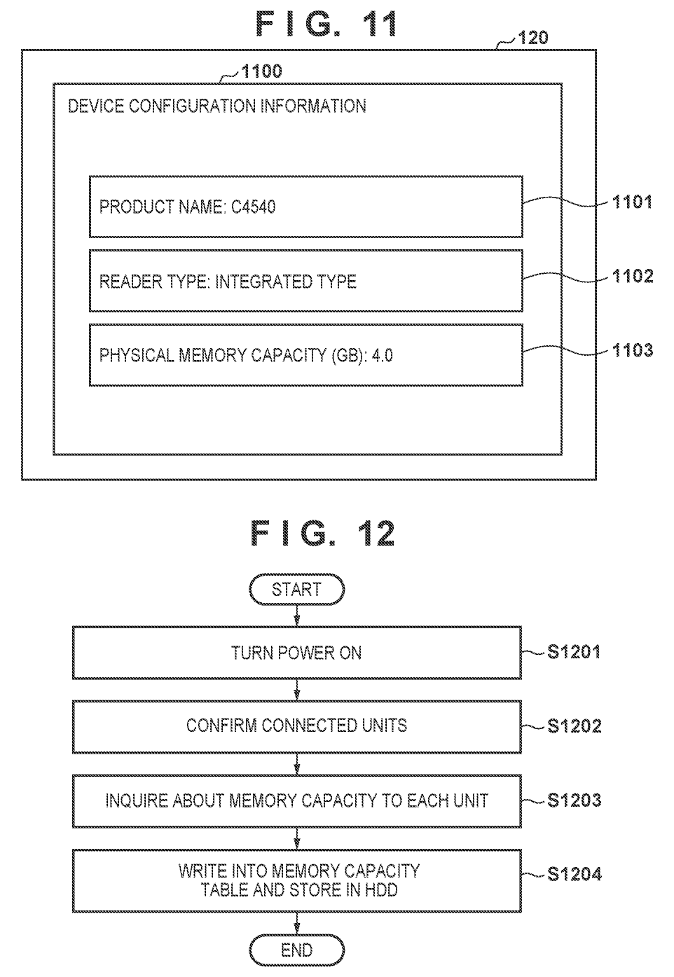

Meanwhile, when it is a separated type, the processing proceeds to step S907 without adding a memory capacity corresponding to the image RAM 164. In step S907, the CPU 151 determines the memory capacity value and displays it on the device configuration information screen 1100 illustrated in FIG. 11. Since the type of the hardware configuration of the reader controller 1010 is stored in advance in the HDD 154 as hardware configuration information, it is possible to determine the type by referencing that configuration information. In the case of an integrated-type reader controller, even in a form in which the reading unit 102 has been removed, the memory capacity is displayed as "4.0 GB" obtained by adding the image RAM 164, as illustrated by reference numeral 1103 on the screen 1100. Further, a product name 1101 and "integrated type" as a reader type 1102 are displayed on the screen 1100.

As described above, the image processing apparatus according to the present embodiment further determines whether a controller of a unit determined not to be connected to the image processing apparatus is an integrated type or a separated type. Furthermore, even if the unit is determined not to be connected to the image processing apparatus, when the controller of the unit is of an integrated type, the image processing apparatus acquires the memory capacity of the unit from the holding unit. Thus, even when an optional unit is not connected, if a controller of a unit is integrally configured with the system controller, it is possible to use its memory, and so, it is possible to perform presentation taking its memory capacity into account.

### Third Embodiment

A third embodiment of the present disclosure will be described below. In the above first and second embodiments, a form in which a memory capacity of each unit of the image processing apparatus 100 is statically held in a table defined in advance has been described. In the present embodiment, a form in which the system controller 150 inquires about memory capacity to each connected unit when the power of the image processing apparatus 100 is turned on and creates (updates) the memory capacity table 400 will be described.

### Processing Procedure

A procedure for generating a table defining a memory capacity of each unit according to the present embodiment will be described with reference to FIG. 12. The processing to be described below is realized, for example, by the CPU 151 of the system controller reading the controller firmware from the ROM 152 and executing it on the RAM 153.

In step S1201, the CPU 151 detects that power has been supplied to the image processing apparatus 100 and starts the processing. In step S1202, the CPU 151 confirms each connected unit. The confirmation method is similar to that of the method for confirming the connection of the reading unit 102 in the above first and second embodiments, and it is determined whether an electrical signal line for confirming the connection of each unit is active.

In step S1203, a memory capacity of each connected unit is inquired about. In step S1204, the CPU 151 writes a memory capacity value returned from each unit to the memory capacity table 400 and stores it in the HDD 154. Since the memory capacity display on a screen for displaying device configuration information thereafter is similar to those of the above first and second embodiments, the description thereof will be omitted.

In the present embodiment, a memory capacity of each unit is inquired about and acquired when the power of the image processing apparatus 100 is turned on, but as described in the above first embodiment, it is possible to replace them with the reading unit 102 of the reader controller 103 of a different type. In that case, the system controller 150 may inquire about capacity from the reader controller 103 at a timing when the display of memory capacity is requested, acquire a capacity value, and display it as the memory capacity 503 or 801.

As described above, the image processing apparatus according to the present embodiment inquires about and acquires a memory capacity for each connected unit when the power of the image processing apparatus is turned on, and updates the held memory capacities with the memory capacity acquired from each unit. Thus, the image processing apparatus can dynamically ascertain memory capacities of optional units and present a memory capacity that takes actually connected optional units into account.

### Modification

The technology of the present disclosure is not limited to the above embodiments, and various modifications are possible. In the above embodiments, an image reading apparatus is described as an example of a detachable optional unit. However, the image processing apparatus according to the present disclosure is not limited thereto, and a plurality of other units are also detachable. For example, various units, such as a post-processing apparatus that performs stapling or binding, a large-capacity stacker that stacks large-volume printed products, and an inspection apparatus that inspects the quality of printed products, are detachable. If such various optional units are provided with a RAM that can be used by a system controller, it is desirable that the image processing apparatus performs presentation with the memory capacities of these RAMs included. A storage memory such as a USB memory or a SSD memory may be connected as an optional unit even in units other than those related to image processing. Even in this case, it is desirable that the image processing apparatus acquires and presents the memory capacity similarly to those of other optional units.

Further, in the above embodiments, an example in which the acquired memory capacity is displayed on the display unit of the image processing apparatus has been described. However, the technology of the present disclosure is not limited thereto, and the acquired memory capacity may be displayed on a display unit of an external apparatus, such as a PC, that is connected to be capable of communicating with the image processing apparatus. Alternatively, the acquired memory capacity may be transmitted to an external apparatus, such as a PC, that is connected to be capable of communicating with the image processing apparatus.

Further, in the above embodiments, it has been described that memory capacity of the image processing apparatus is presented. However, the technology of the present disclosure is not limited thereto, and current memory usage and usage with respect to memory capacity may also be presented. In this case, memory usage for each unit may be presented.

According to the technology of the present disclosure, for example, it is possible to provide a mechanism that suitably presents memory capacity according to a configuration of an image processing system.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157738, filed September 11, 2024, hereby incorporated by reference herein in its entirety.

What is claimed is:

1. An image processing apparatus comprising:
a storage unit that stores a set of instructions; and
one or more processors that execute the set of instructions to:
acquire a capacity of another storage unit, the other storage unit being a storage unit of at least one unit connected to the image processing apparatus; and
cause a display unit to display a storage capacity based on the capacity of the acquired other storage unit and a capacity of the storage unit of the image processing apparatus.

2. The image processing apparatus according to claim 1, wherein
the one or more processors execute instructions in the storage device to:
identify the capacity of the storage unit of the image processing apparatus, and
cause the display unit to display the storage capacity based on the capacity of the acquired other storage unit and the identified capacity.

3. The image processing apparatus according to claim 1, wherein
the one or more processors execute instructions in the storage device to:
cause the display unit display a total of the capacity of the acquired other storage unit and the capacity of the storage unit of the image processing apparatus.

4. The image processing apparatus according to claim 1, wherein
the one or more processors execute instructions in the storage device to:
add the capacity of the acquired other storage unit and the capacity of the storage unit of the image processing apparatus,
cause the display unit to display a result of addition.

5. The image processing apparatus according to claim 1, wherein
the one or more processors execute instructions in the storage device to:
acquire capacities of a plurality of storage units included in a plurality of units connected to the image processing apparatus, and
cause the display unit to display respective capacities of the plurality of storage units.

6. The image processing apparatus according to claim 5, wherein
the plurality of units include a scanner.

7. The image processing apparatus according to claim 5, wherein
the plurality of units include a finisher that performs stapling.

8. The image processing apparatus according to claim 1, wherein
the one or more processors execute instructions in the storage device to:
cause the display unit to display a capacity of the other storage unit in use.

9. The image processing apparatus according to claim 1, wherein
the one or more processors execute instructions in the storage device to:
perform control to display the storage capacity on a display unit of an external apparatus capable of communicating with the image processing apparatus.

10. A method for controlling an image processing apparatus including a storage unit, the method comprising:
acquiring a capacity of another storage unit, the other storage unit being a storage unit of at least one unit connected to the image processing apparatus; and
displaying a storage capacity based on the acquired capacity of the other storage unit and a capacity of the storage unit of the image processing apparatus.

11. A non-transitory computer-readable storage medium storing a program for causing a computer to execute a method for controlling an image processing apparatus including a storage unit, the method comprising:
acquiring a capacity of another storage unit, the other storage unit being a storage unit of at least one unit connected to the image processing apparatus; and
displaying a storage capacity based on the acquired capacity of the other storage unit and a capacity of the storage unit of the image processing apparatus.
